(19) United States
(12) Patent Application Publication
(10) Pub. No.: US 2002/0152411 A1
(43) Pub. Date: Oct. 17, 2002

(54) Timing multiple events with a single timer

(76) Inventors: Ronald D. Olsen, Lake View, NY (US); Jon C. Melnik, Alden, NY (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/835,034

(22) Filed: Apr. 13, 2001

(51) Int. Cl. G06F 1/04; G06F 1/06; G06F 1/08

(52) U.S. Cl. 713/500

(57) ABSTRACT

A method and an article of manufacture for timing multiple events using a single timer are described.

### BACKGROUND INFORMATION

The invention relates generally to devices and methods to time events. In existing computer-based systems, a timer is required for each type of event to be timed. Using many timers can tie up valuable computing time.

### BRIEF DESCRIPTION OF THE DRAWINGS

Reference should be made to the following detailed description taken in conjunction with the accompanying drawings, in which:

FIGS. 1A through 1C are a block flow diagram of one method in accordance with an embodiment of the invention;

FIGS. 2A and 2B are a block flow diagram of a second method in accordance with an embodiment of the invention;

FIGS. 3A and 3B are a block flow diagram of a third method in accordance with an embodiment of the invention;

FIG. 4 is a time line illustrating aspects of a method in accordance with an embodiment of the invention; and

FIG. 5 illustrates an article of manufacture in accordance with an embodiment of the invention.

### DETAILED DESCRIPTION

Before providing certain details, an overview of a method according to an embodiment of the invention may be helpful. In a method according to an embodiment of the invention, a set of durations may be received. The set of durations includes at least two time durations, and each duration corresponds to a respective action signal to be sent at the end of the respective duration. An expiration time corresponding to each duration may be determined, and the expiration time that is first to occur may be selected. When the selected expiration time occurs, the action signal corresponding to the selected expiration time may be sent. The foregoing procedure may be repeated with the next expiration time(s) until there are no more expiration times to be selected. As a result, a method according to an embodiment of the invention allows for the use of a single timer to time multiple events.

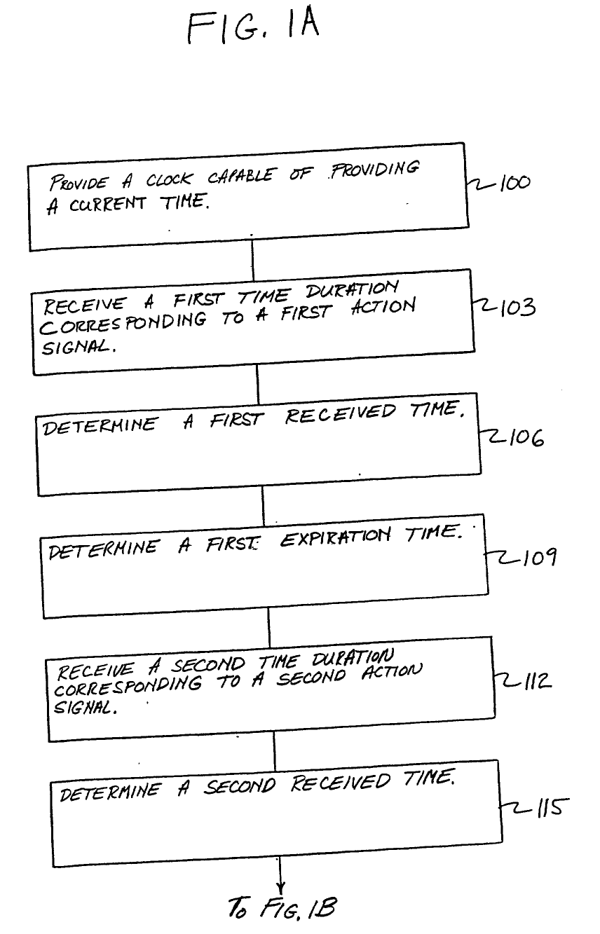

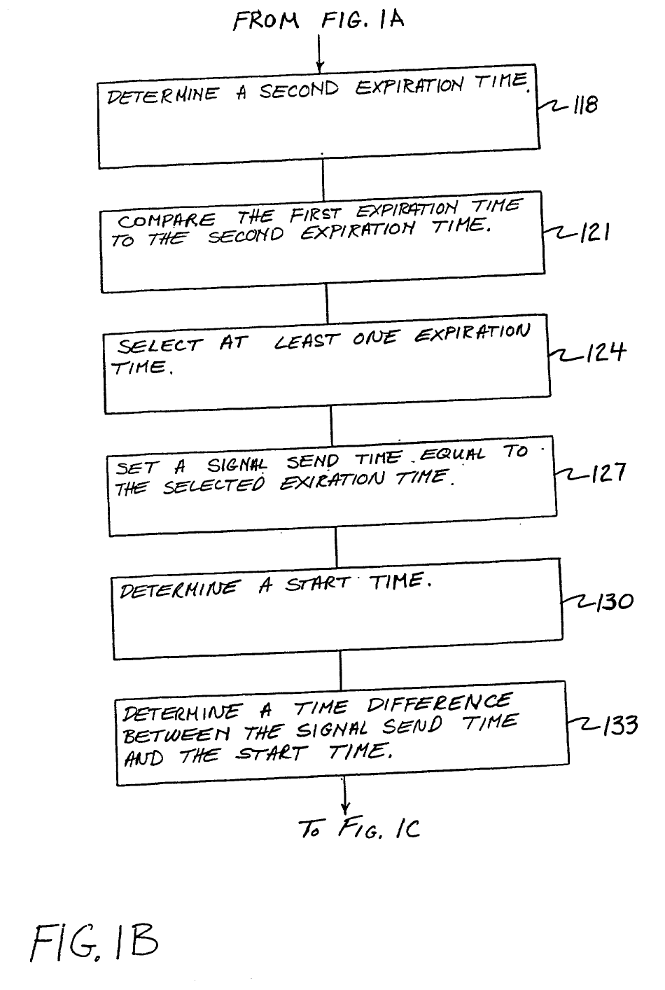

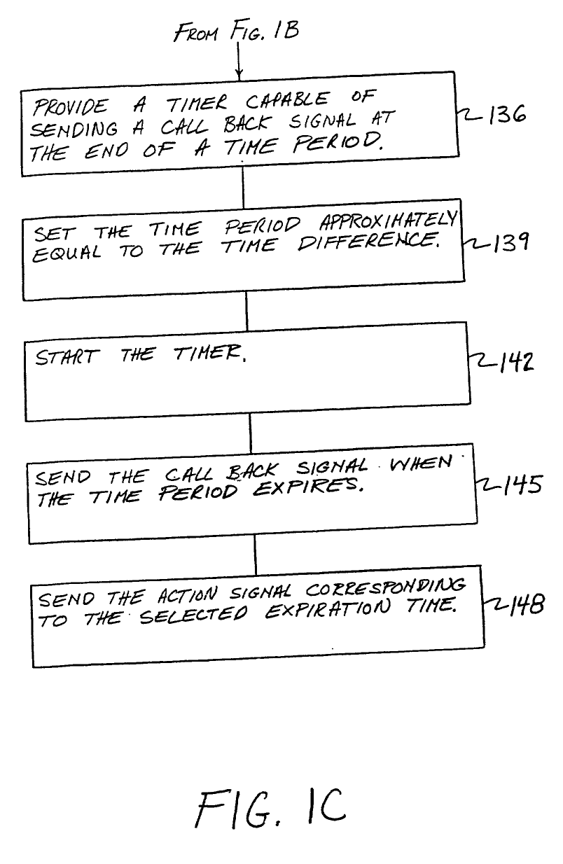

FIGS. 1A through 1C depict a method of determining when to send a signal according to an embodiment of the invention. A clock, capable of indicating a current time, may be provided 100. The clock may be the system clock of a computer. A first time duration corresponding to a first action signal may be received 103. The time duration may be the amount of time that should be allowed to lapse before an action is taken. For example, many software programs require certain routines to pause for a specified duration to allow other routines to be executed. In that situation, the time period corresponding to the pause may be the first time duration. At the end of the first time duration, the paused routines may be started, for example, by the first action signal.

A first received time may be determined 106. The first received time may correspond to the current time indicated by the clock when the first time duration was received. Next, a first expiration time may be determined 109. The first expiration time may be approximately equal to the first received time plus the first time duration.

A second time duration corresponding to a second action signal may be received 112. The second time duration may be similar to the first time duration in that the second time duration may also be related to a pause in a routine, and similarly the second action signal may also be a signal that starts that routine after the pause.

A second received time and second expiration time may be determined 115, 118. The second received time corresponds to the current time indicated by the clock when the second time duration was received. The second expiration time may be approximately equal to the second received time plus the second time duration.

Next, the first expiration time may be compared 121 to the second expiration time, and one or both of the expiration times may be selected 124. The first expiration time may be selected if the first expiration time is less than the second expiration time. The second expiration time may be selected if the second expiration time is less than the first expiration time. Both the first and second expiration times may be selected if the first expiration time is approximately equal to the second expiration time.

A signal send time may be determined. If the first expiration time is not approximately equal to the second expiration time, the signal send time may be set 127 approximately equal to the selected one of the first expiration time and the second expiration time. However, if the first expiration time is approximately equal to the second expiration time, the signal send time may be set 127 approximately equal to the first and second expiration time.

A start time corresponding to the current time indicated by the clock may be determined 130, and a time difference between the signal send time and the start time may be determined 133. A timer, capable of sending a call back signal at the end of a time period, may be provided 136, and the time period may be set 139 approximately equal to the time difference. Then the timer may be started 142 at the start time, and once the timer sends 145 the call back signal, the first action signal may be sent 148 if the first expiration time was selected, and the second action signal may be sent if the second expiration time was selected.

In order to make sure there is time to execute portions of the method, for example sending the call back signal and then sending the action signal at the expiration time, the time period may be made less than the time difference. It is therefore anticipated that the time period may not be equal to the time difference, but instead may be equal to the time difference minus some amount of time needed to execute portions of the method, such as those portions that occur from the time a call back signal is sent to the time an action signal is sent.

Once the time period has expired and the timer sends the call back signal, a next expiration time may be selected. The next expiration time may correspond to the first expiration time if the first expiration time was not previously selected, and the next expiration time may correspond to the second expiration time if the second expiration time was not previously selected. Then a new start time may be determined, and a new time difference between the next expiration time and the new start time may be determined. Then the time period may be set approximately equal to the new time difference, and the timer may be started at the new start time. This process may be repeated until there are no more expiration times to be selected.

In an embodiment of the invention, indicators corresponding to time durations may be provided. An indicator indicates whether the corresponding time duration should be received again after the corresponding action signal has been sent. As an example of this embodiment, upon sending the first action signal, the first indicator may be checked and if the first indicator indicates the first action signal should be sent again, the first time duration may be received again. Then a third received time may be determined. The third received time corresponds to the current time indicated by the clock when the first time duration was received again, or alternatively, when the first action signal was sent. Then, a third expiration time may be determined. The third expiration time may be approximately equal to the third received time plus the first time duration. The method may proceed using the third expiration time and information corresponding to the second expiration time.

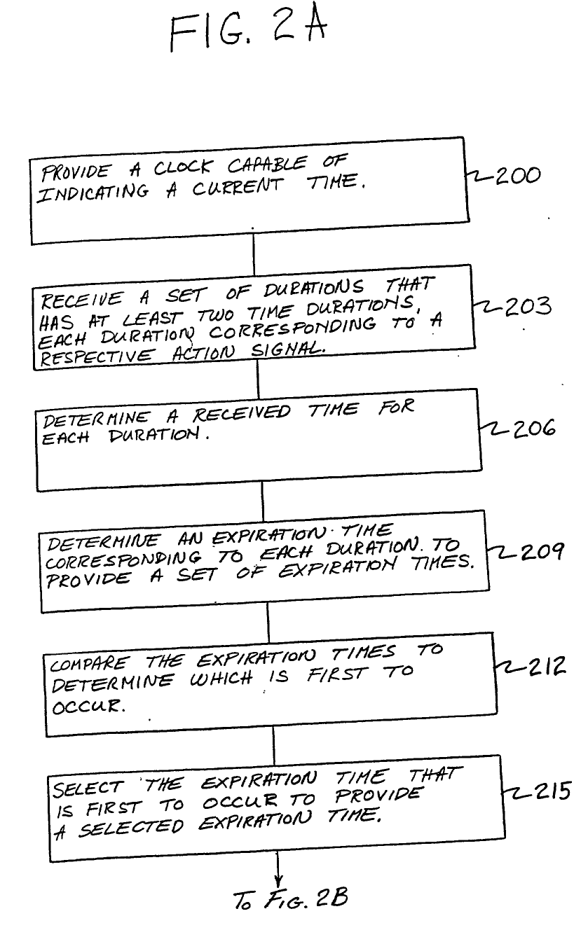

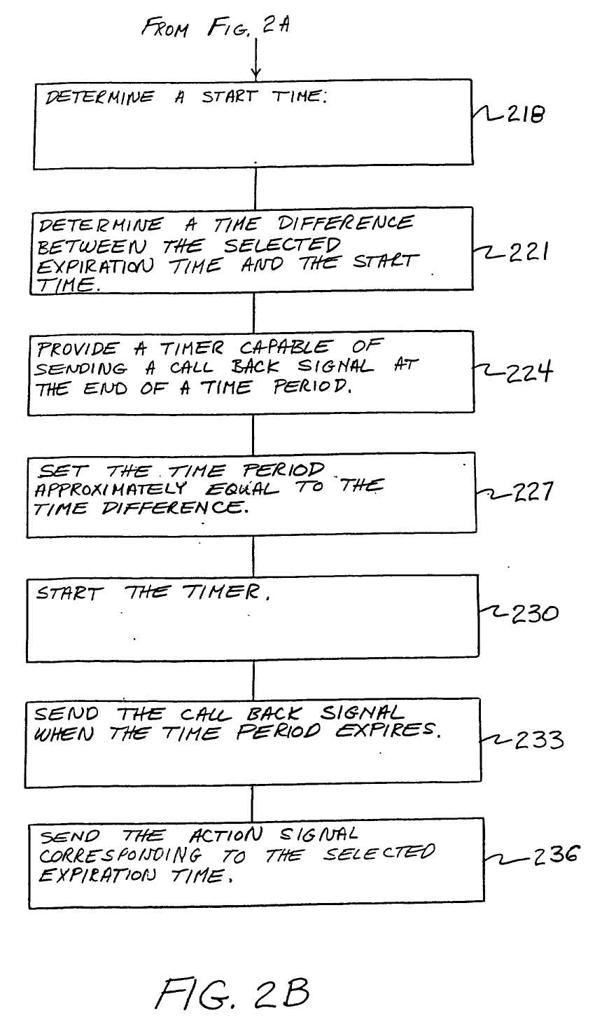

FIGS. 2A and 2B illustrate another method according to an embodiment of the invention. In this method a clock, capable of indicating a current time, may be provided 200, and a set of durations may be received 203. The set of durations includes at least two time durations, each duration corresponding to a respective action signal to be sent at the end of the respective duration. A received time for each duration may be determined 206, each received time being the current time indicated by the clock when the duration was received. An expiration time corresponding to each duration may be determined 209 to provide a set of expiration times. Each expiration time may be approximately equal to the corresponding received time plus the corresponding time duration. Then the expiration times may be compared 212 to determine which of the expiration times is first to occur. The expiration time that is first to occur may be selected 215 to provide a selected expiration time.

Then a start time may be determined 218, and a time difference between the selected expiration time and the start time may be determined 221. The start time may be the current time indicated by the clock.

A timer that is capable of sending a call back signal at the end of a time period may be provided 224. The time period may be set 227 approximately equal to the time difference, and the timer may be started 230 at the start time. At the end of the time period, the call back signal may be sent 233. Once the call back signal is sent, all action signals corresponding to an expiration time that corresponds to the selected expiration time may be sent 236 at the selected expiration time. As described above, it may be beneficial to make the time period less than the time difference to allow for the time needed to perform portions of the method before sending the action signal.

After the time period expires, the expiration time that is next to occur may be selected from the set of expiration times. A new start time may be determined, and a new time difference between the selected expiration time that is next to occur and the start time may be determined. The time period may be set approximately equal to the new time difference, and the timer may be started at the new start time. At the end of the time period, the timer may again send a call back signal, and the action signals that correspond to an expiration time corresponding to the selected expiration time that is next to occur may be sent at the selected expiration time.

The method may further include adding an expiration time to the set of expiration times. For example, it may be desirable for a time duration to be effectively received again after the corresponding action signal has been sent. In that situation, an expiration time may be added to the set of expiration times that may be approximately equal to the time the action signal was sent plus the corresponding duration. One way of accomplishing this may be to provide an indicator corresponding to the sent action signal. The indicator may be provided along with the corresponding duration. Once the action signal is sent, the indicator may be checked to determine whether the indicator is turned on or turned off. If the indicator is turned on, the expiration time may be determined and added to the set of expiration times.

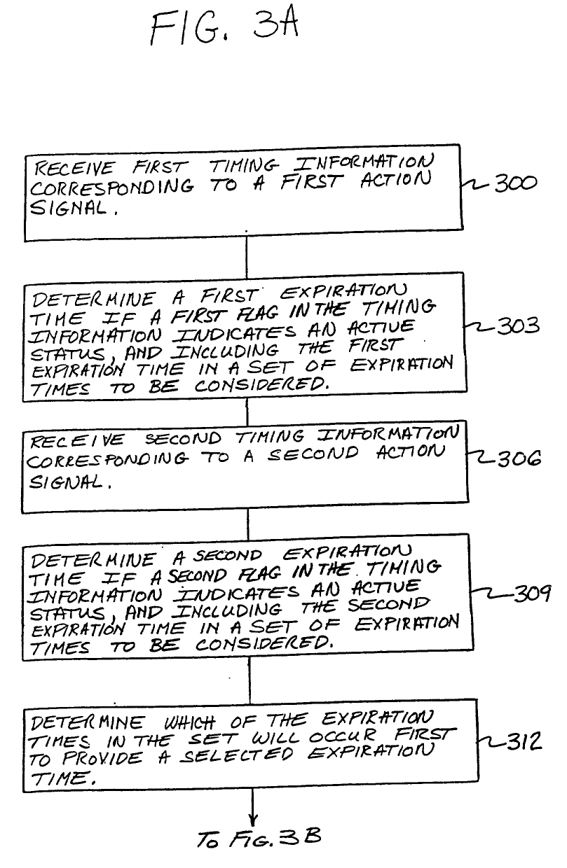

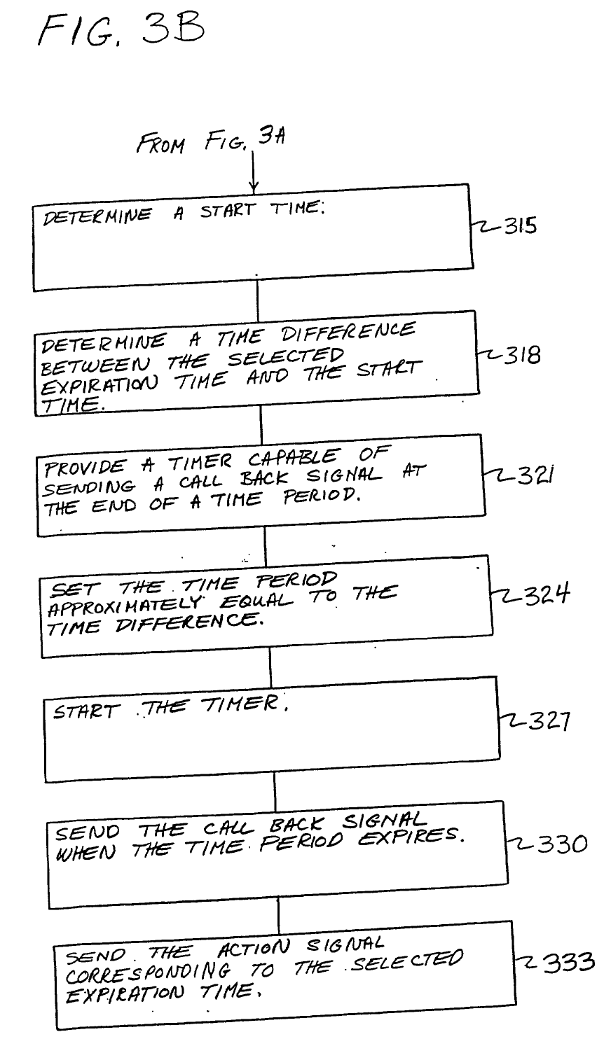

FIGS. 3A and 3B illustrate another method according to an embodiment of the invention. In this method, first timing information may be received 300. The first timing information corresponds to a first action signal and includes a first duration and a first flag. The flag may be turned on or turned off, for example by a computer software routine. The flag may be used to indicate whether the duration should be used, and ultimately, whether the corresponding action signal should be sent at the end of the duration. If the first flag is turned on, indicating an active status, a first expiration time may be determined 303 and included in a set of expiration times to be considered.

Second timing information also may be received 306 that corresponds to a second action signal. The second timing information includes a second duration and a second flag. If the second flag indicates an active status, then a second expiration time may be determined 309 and included in the set of expiration times. Then a determination 312 may be made as to which of the expiration times in the set will occur first, in order to provide a selected expiration time.

A start time may be determined 315, and a time difference, approximately equal to a difference between the selected expiration time and the start time, may be determined 318. Then a timer, capable of sending a call back signal at the end of a time period, may be provided 321, and the time period may be set 324 approximately equal to the time difference. As noted above, it may be beneficial to make the time period less than the time difference to allow for the time needed to perform portions of the method before sending the action signal. The timer may be started 327 at the start time, and once the time period has expired, the timer sends 330 the call back signal. Action signals that correspond to an expiration time corresponding to the selected expiration time may be sent 333.

After the call back signals are sent, at least one of the flags corresponding to the selected expiration time may be set to an inactive status. To accomplish this, the timing information may include an indicator, as described above. For example, if a first indicator corresponding to first timing information is provided, then upon sending the first action signal, a determination may be made as to whether the indicator is turned on or turned off. If the first indicator is turned on and the first flag indicates an active status, then a third expiration time may be determined. The third expiration time corresponds to the first action signal, and may be computed by adding the first duration to the current time indicated by the clock when the first action signal was sent. Once the third expiration time is determined, the third expiration time may be included in the set of expiration times to be considered. Then a determination may be made as to which of the expiration times in the set will next occur in order to provide a new expiration time. A new start time may be determined, and the time period may be set approximately equal to a difference between the new expiration time and the new start time. Then the timer may be started at the new start time, and once the new time period expires, the timer sends the call back signal, and action signals that correspond to an expiration time that corresponds to the new expiration time may be sent.

If it is determined that the indicator is turned off, then once the corresponding action signal is sent, the first flag may be set to an inactive status. In this situation, in order to cause the corresponding timing information to again be considered, and ultimately to again send the corresponding action signal, the flag would need to be set to an active status, for example by a computer software routine.

It will now be recognized that the timer may need to be capable of accounting for time periods that are shorter than the shortest duration. If the timer can account for relatively short time periods, the time period accounted for by the timer can be made shorter than the time difference referenced above so that there is time to determine the time difference, set the time period, start the timer and send the call back signal before the action signal must be sent.

In addition, it will now be recognized that the invention allows for the use of a single timer to time multiple events. An embodiment of the invention may be implemented so that if the timer is currently timing a particular time period corresponding to a particular expiration time and a duration is received, an expiration time corresponding to that newly received duration may be determined. The newly determined expiration time may be compared to the expiration time that corresponds to the time period being accounted for by the timer. If the newly received expiration time is earlier than the expiration time corresponding to the time period being accounted for, then a new time period may be determined that corresponds to the newly received expiration time. The timer may be set with the new time period, and then started.

There may be a situation in which there are no more expiration times or corresponding durations for which a corresponding action signal should be sent. In those situations, the timer may be turned off, or placed in a ready-state awaiting for the next duration to be received.

When an embodiment of the invention is implemented on a computer to time events required by computer software, the application interface to the portion of the software needing timer support may be very simple. Many of the execution steps related to timing an event are done in a manner that requires few pieces of information from, and very little interaction with, the computer software needing timer support.

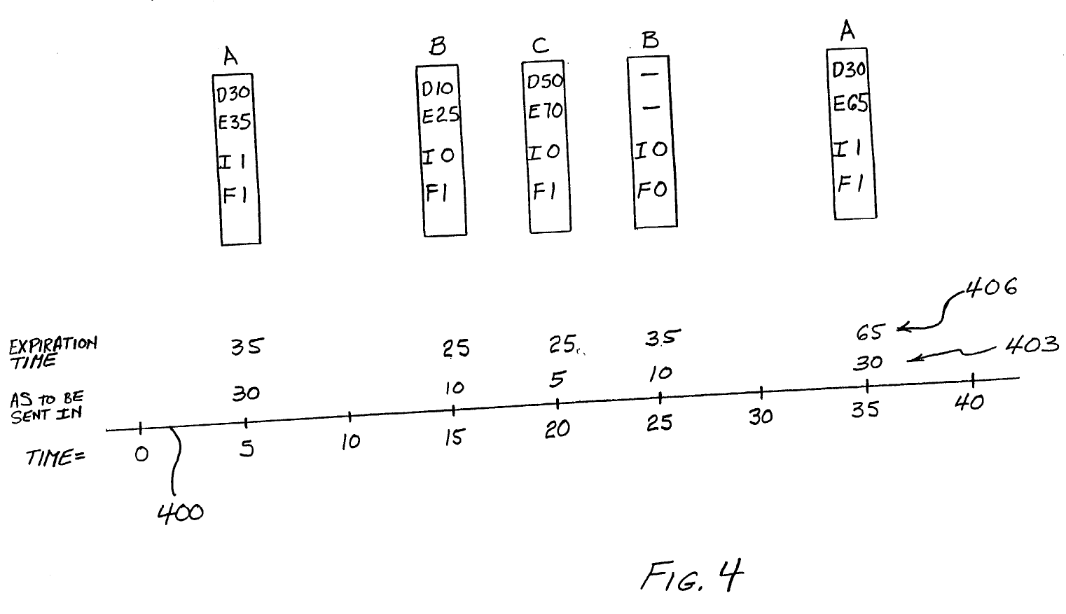

Certain aspects of an embodiment of the invention will now be illustrated by way of an example. FIG. 4 shows a time line 400 that starts at time=0 and extends through time=40. Every five units of time are marked on the time line 400 for reference purposes. Immediately above the time line is a row of information 403 labeled “AS to be sent in”, and the information in this row 403 reflects the time remaining before an action signal (“AS”) is sent. Immediately above the “AS to be sent in” row 403 is a row 406 titled “expiration time”, and the information in this row 406 reflects the expiration time for which the timer is currently accounting.

For purposes of this example, assume timing information A is received at time=5. The box labeled “A” above time=5 shows the status of timing information A at time=5. Timing information A includes a duration of 30 time units (signified by the “C” next to the number 30). The corresponding expiration time is therefore at time=35 (signified by the “E” next to the number 35). Also included in timing information A may be an indicator that has been turned on (signified by the number 1 next to the “I”) and a flag that may be in the active state (signified by the number 1 next to the “F”).

Assuming timing information A is the only piece of timing information pending at time 5, the expiration time is determined to be time=35. A start time and time period are selected so that the action signal will be sent at time=35, and the timer is started.

At time=14.9, the timer is still timing the time period corresponding to timing information A. Then, at time=15, timing information B is received. The box labeled “B” above time=15 shows the status of timing information B at time=15. Timing information B has a duration of 10 time units, an indicator in the “off” state, and a flag in the “active” state. An expiration time corresponding to timing information B is determined to be time=25. The expiration time corresponding to timing information A (time=35) is compared to the expiration time corresponding to timing information B (time=25). Since the expiration time corresponding to timing information B will occur first, a start time and time period are selected so that the action signal corresponding to timing information B will be sent at time=25, and the timer is started.

At time=19.9, the timer is still accounting for the time period corresponding to timing information B. Then, at time=20, timing information C is received. Timing information C has a duration of 50 time units, an indicator in the “off” state, and a flag in the “active” state. An expiration time corresponding to timing information C is determined to be time=70. The expiration time corresponding to timing information B (time=25) is compared to the expiration time corresponding to timing information C (time=70). Since the expiration time corresponding to timing information B will occur first, the timer is not reset, and is allowed to continue accounting for the existing time period, of which there are 5 time units remaining when timing information C is received.

Next, the timer sends a call back signal, and the action signal corresponding to timing information B is sent at time=25. Since the indicator in timing information B is in the “off” state, the flag is set to the “inactive” state. The flag may be changed to the “active” state upon a command to do so from the software associated with timing information B. The box labeled “B” above time=25 shows the status of timing information B at time=25.

After the call back signal is sent, the expiration times corresponding to the remaining pieces of timing information, timing information A and timing information C, are compared. Since the expiration time corresponding to timing information A (time=35) will occur before the expiration time corresponding to timing information C (time=70), a start time and time period are selected so that the action signal corresponding to timing information A will be sent at time=35, and the timer is started.

At time=34.9, the timer is accounting for the time period corresponding to timing information A. When the time period expires, the timer sends the call back signal, and at time=35 the action signal corresponding to timing information A is sent. Since timing information A has an indicator that is turned on, the 30 time unit duration of timing information A is again used. The expiration time corresponding to timing information A is then determined to be time=65. The box labeled “A” above time=35 shows the status of timing information A at time=35. The expiration time corresponding to timing information A (time=65) is compared to the expiration time corresponding to timing information C (time=70), and the expiration time corresponding to timing information A is determined to be the first to occur. A start time and time period are selected so that the action signal corresponding to timing information A will be sent at time=65, and the timer is started.

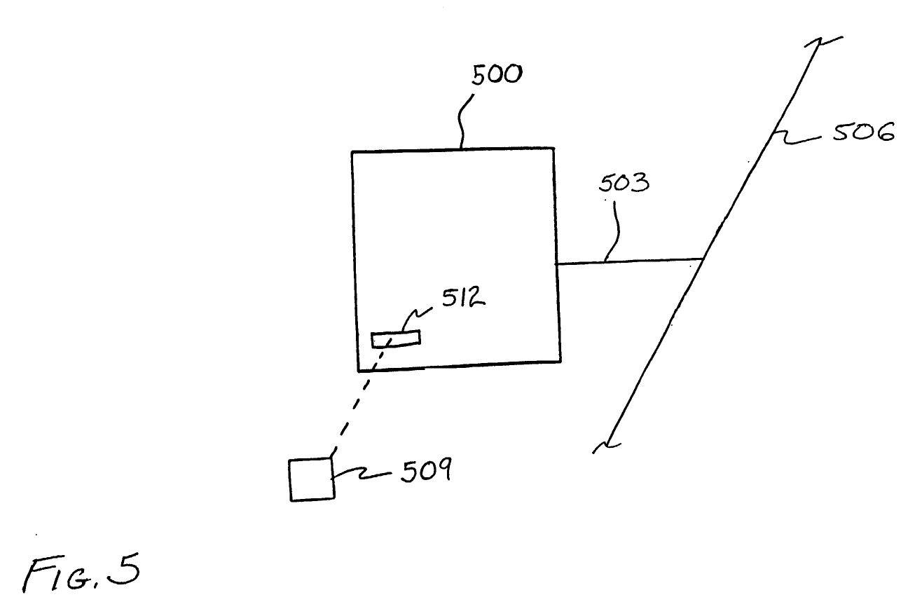

FIG. 5 shows an embodiment of a system according to the invention wherein a computer 500 has computer software running thereon. The computer 500 may be connected via a connection line 503 to a transmission line 506 carrying requests for a timer and a return action signal. The computer software may be stored on an article of manufacture 509, such as a computer readable storage medium, for example a compact-disc, and loaded onto the computer 500, for example via a compact-disc drive 512.

An embodiment of an article of manufacture according to the present invention is a computer usable medium having computer readable program code instructions embodied therein to cause a computer to determine when to send a signal. The instructions may have computer readable program code modules to (a) cause the computer 500 to receive a first time duration corresponding to a first action signal, (b) cause the computer 500 to determine a first received time corresponding to the current time indicated by a clock when the first time duration was received, (c) cause the computer 500 to determine a first expiration time, the first expiration time being approximately equal to the first received time plus the first time duration, (d) cause the computer 500 to receive a second time duration corresponding to a second action signal, (e) cause the computer 500 to determine a second received time corresponding to the current time indicated by the clock when the second time duration was received, (f) cause the computer 500 to determine a second expiration time, the second expiration time being approximately equal to the second received time plus the second time duration, (g) cause the computer 500 to compare the first expiration time to the second expiration time, (h) cause the computer 500 to select the first expiration time if the first expiration time is less than the second expiration time, and to cause the computer 500 to select the second expiration time if the second expiration time is less than the first expiration time, and to cause the computer 500 to select both the first and second expiration times if the first expiration time is approximately equal to the second expiration time, (i) cause the computer 500, if the first expiration time is not approximately equal to the second expiration time, to set a signal send time approximately equal to the selected one of the first expiration time and the second expiration time, and to cause the computer 500, if the first expiration time is approximately equal to the second expiration time, to set a signal send time approximately equal to the first and second expiration time, (j) cause the computer 500 to determine a start time corresponding to the current time indicated by the clock, (k) cause the computer 500 to determine a time difference between the signal send time and the start time, (l) cause the computer 500 to set a time period of a timer approximately equal to the time difference so a call back signal is sent at the end of the time period, (m) cause the computer 500 to start the timer at the start time, and (n) cause the computer 500 to send, once the timer sends the call back signal, the first action signal if the first expiration time was selected, and to send the second action signal if the second expiration time was selected.

The computer readable program code instructions in the article of manufacture may also have modules that (a) cause the computer 500 to select a next expiration time once the timer sends the call back signal, wherein the next expiration time may correspond to the first expiration time if the first expiration time was not previously selected, and the next expiration time may correspond to the second expiration time if the second expiration time was not previously selected, (b) cause the computer 500 to determine a new start time, and (c) cause the computer 500 to determine a new time difference between the next expiration time and the new start time. Furthermore, the computer readable program code instructions may include a module that causes the computer 500 to set the time period approximately equal to the new time difference, and that causes the computer 500 to start the timer at the new start time.

The computer readable program code instructions on the article of manufacture may also have modules that (a) cause the computer 500 to check a first indicator upon sending the first action signal, the first indicator corresponding to whether the first action signal should be sent again, (b) cause the computer 500 to receive again the first time duration if the first indicator indicates the first action signal should be sent again, (c) cause the computer 500 to determine a third received time corresponding to the current time indicated by the clock when the first time duration was received again, and (d) cause the computer 500 to determine a third expiration time, the third expiration time being approximately equal to the third received time plus the first time duration.

A second example of the computer readable program code instructions on the article of manufacture may have modules that (a) cause the computer 500 to receive a set of durations, the set of durations including at least two time durations, each duration corresponding to a respective action signal to be sent at the end of the respective duration, (b) cause the computer 500 to determine a received time for each duration, each received time being a current time indicated by a clock when the duration was received, (c) cause the computer 500 to determine an expiration time corresponding to each duration to provide a set of expiration times, each expiration time being approximately equal to the corresponding received time plus the corresponding time duration, (d) cause the computer 500 to compare the expiration times to determine which of the expiration times is first to occur, (e) cause the computer 500 to select the expiration time that is first to occur to provide a selected expiration time, (f) cause the computer 500 to determine a start time corresponding to the current time indicated by the clock, (g) cause the computer 500 to determine a time difference between the selected expiration time and the start time, (h) cause the computer 500 to set a time period of a timer approximately equal to the time difference, the timer being capable of sending a call back signal at the end of the time period, (i) cause the computer 500 to start the timer at the start time, and (j) cause the computer 500 to send, once the timer sends the call back signal, the action signal that corresponds to an expiration time corresponding to the selected expiration time.

The computer readable program code instructions may include modules that (a) cause the computer 500 to select from the set of expiration times the expiration time that is next to occur, (b) cause the computer 500 to determine a new start time corresponding to the current time indicated by a clock, (c) cause the computer 500 to determine a new time difference between the selected expiration time that is next to occur and the start time, (d) cause the computer 500 to set the time period approximately equal to the new time difference, (e) cause the computer 500 to start the timer at the new start time, (f) cause the computer 500 to send, once the timer sends the call back signal, the action signal that corresponds to an expiration time corresponding to the selected expiration time that is next to occur.

The computer readable program code instructions may include a module that causes the computer 500 to add to the set of expiration times an expiration time that is approximately equal to the time the action signal was sent plus the corresponding duration. Furthermore, the second example of the computer readable program code instructions may include a module that causes the computer 500 to check an indicator corresponding to the sent action signal to determine whether the indicator is turned on or turned off, and may also have a module that causes the computer 500 to add to the set of expiration times an expiration time approximately equal to the time the action signal was sent plus the corresponding duration, if the indicator is turned on.

In a third example of the computer readable program code instructions there may be modules that (a) cause the computer 500 to receive first timing information corresponding to a first action signal, the first timing information including a first duration and a first flag, (b) cause the computer 500 to determine a first expiration time, if the first flag indicates an active status, and to include the first expiration time in a set of expiration times to be considered, (c) cause the computer 500 to receive second timing information corresponding to a second action signal, the second timing information including a second duration and a second flag, (d) cause the computer 500 to determine a second expiration time, if the second flag indicates an active status, and to include the second expiration time in the set of expiration times, (e) cause the computer 500 to determine which of the expiration times in the set will occur first, to provide a selected expiration time, (f) cause the computer 500 to determine a start time, (g) cause the computer 500 to set a time period of a timer approximately equal to a difference between the selected expiration time and the start time, the timer being capable of sending a call back signal at the end of the time period, (h) cause the computer 500 to start the timer at the start time, (i) cause the computer 500 to send, once the timer sends the call back signal, action signals that correspond to an expiration time corresponding to the selected expiration time.

The computer readable program code instructions may include a module that causes the computer 500 to set at least one of the flags corresponding to the selected expiration time to an inactive status once the corresponding action signal is sent. Furthermore, the third example of the computer readable program code instructions may also have a module that handles timing information that includes a first indicator. Such a module may cause the computer to (a) determine whether the indicator is turned on or turned off upon sending the first action signal, (b) determine whether the first flag indicates an active status, (c) determine a third expiration time corresponding to the first action signal, if the first flag indicates an active status and the indicator is turned on, and to include the third expiration time in the set of expiration times to be considered, (d) determine which of the expiration times in the set will next occur to provide a new expiration time, (e) determine a new start time, (f) set the time period approximately equal to a difference between the new expiration time and the new start time, (g) start the timer at the new start time, and (h) to send, once the timer sends the call back signal, action signals that correspond to an expiration time corresponding to the new expiration time.

When the first timing information further includes an indicator, the computer readable program code instructions may include modules that cause the computer 500 to (a) determine, upon sending the first action signal, whether the first indicator is turned on or turned off, and (b) set the first flag to an inactive status if the first indicator is turned off.

Although the invention has been described with respect to one or more particular embodiments, it will be understood that other embodiments of the invention may be made without departing from the spirit and scope of the invention.

What is claimed is:

1. A method to determine when to send a signal, comprising:
receiving a set of durations, the set of durations including at least two time durations, each duration corresponding to a respective action signal to be sent at the end of the respective duration;
determining an expiration time corresponding to each duration;
selecting the expiration time that is first to occur to provide a selected expiration time;
sending the action signal corresponding to the selected expiration time when the selected expiration time occurs.

2. The method of claim 1, wherein determining an expiration time corresponding to each duration includes determining a received time for each duration.

3. The method of claim 2, wherein determining an expiration time corresponding to each duration further includes adding each duration to its corresponding received time.

4. The method of claim 1, wherein selecting the expiration time that is first to occur includes comparing the expiration times to determine which of the expiration times is first to occur.

5. The method of claim 1, further including determining when the selected expiration time occurs by setting a clock to send a signal at the expiration time.

6. A method to determine when to send a signal, comprising:
determining a first expiration time and a second expiration time;
comparing the first expiration time to the second expiration time;
selecting the first expiration time if the first expiration time is less than the second expiration time, and selecting the second expiration time if the second expiration time is less than the first expiration time, and selecting both the first and second expiration times if the first expiration time is approximately equal to the second expiration time;
if the first expiration time is not approximately equal to the second expiration time, setting a signal send time approximately equal to the selected one of the first expiration time and the second expiration time, and if the first expiration time is approximately equal to the second expiration time, setting a signal send time approximately equal to the first and second expiration time;
determining a start time;
determining a time difference between the signal send time and the start time;
setting a time period approximately equal to the time difference;
setting a timer to send a call back signal at the end of the time period;
starting the timer at the start time; and
once the timer sends the call back signal, sending the first action signal if the first expiration time was selected, and sending the second action signal if the second expiration time was selected.

7. The method of claim 6, further comprising:
receiving a first time duration corresponding to a first action signal; and
determining a first received time corresponding to a current time indicated by a clock when the first time duration was received.

8. The method of claim 7, wherein the first expiration time is approximately equal to the first received time plus the first time duration.

9. The method of claim 6, further comprising, once the timer sends the call back signal:
selecting a next expiration time, the next expiration time corresponding to the first expiration time if the first expiration time was not previously selected, and the next expiration time corresponding to the second expiration time if the second expiration time was not previously selected;
determining a new start time;
determining a new time difference between the next expiration time and the new start time;
setting a new time period approximately equal to the new time difference;
setting the timer to send a new call back signal at the end of the new time period; and
starting the timer at the new start time.

10. The method of claim 6, further comprising:
checking a first indicator upon sending the first action signal, the first indicator corresponding to whether the first action signal should be sent again; and
determining a third expiration time if the first indicator indicates the first action signal should be sent again.

11. A method to determine when to send a signal, comprising:
receiving a set of durations, the set of durations including at least two time durations, each duration corresponding to a respective action signal to be sent at the end of the respective duration;
determining a received time for each duration;
determining an expiration time corresponding to each duration to provide a set of expiration times, each expiration time being approximately equal to the corresponding received time plus the corresponding time duration;
comparing the expiration times to determine which of the expiration times is first to occur;
selecting the expiration time that is first to occur to provide a selected expiration time;
determining a start time;
determining a time difference between the selected expiration time and the start time;
setting a time period approximately equal to the time difference;
setting a timer to send a call back signal at the end of the time period;
starting the timer at the start time; and
once the timer sends the call back signal, sending the action signal that corresponds to the selected expiration time.

12. The method of claim 11, further comprising;
selecting from the set of expiration times the expiration time that is next to occur;
determining a new start time;
determining a new time difference between the selected expiration time that is next to occur and the start time;
setting a new time period approximately equal to the new time difference;
starting the timer at the new start time; and
once the timer sends the call back signal, sending the action signal that corresponds to the selected expiration time that is next to occur.

13. The method of claim 11, further comprising adding to the set of expiration times an expiration time approximately equal to the time the action signal was sent plus the corresponding duration.

14. The method of claim 11, further comprising:
checking an indicator corresponding to the sent action signal to determine whether the indicator is turned on or turned off;
if the indicator is turned on, determining an expiration time approximately equal to the time the action signal was sent plus the corresponding duration.

15. A method to determine when to send a signal, comprising:
receiving first timing information corresponding to a first action signal, the first timing information including a first duration and a first flag;
if the first flag indicates an active status, determining a first expiration time, and including the first expiration time in a set of expiration times to be considered;
receiving second timing information corresponding to a second action signal, the second timing information including a second duration and a second flag;
if the second flag indicates an active status, determining a second expiration time and including the second expiration time in the set of expiration times;
selecting an expiration time in the set that will occur first, to provide a selected expiration time;
determining a start time;
determining a time difference between the selected expiration time and the start time;
setting a time period approximately equal to the time difference;
setting a timer to send a call back signal at the end of the time period;
starting the timer at the start time; and
once the timer sends the call back signal, sending an action signal that corresponds to the selected expiration time.

16. The method of claim 15, wherein at least one of the flags corresponding to the selected expiration time is set to an inactive status once the corresponding action signal is sent.

17. The method of claim 15, wherein the first timing information further includes a first indicator, and the method further comprises:
upon sending the first action signal, determining whether the indicator is turned on or turned off;
determining whether the first flag indicates an active status;
if the first flag indicates an active status and the indicator is turned on, determining a third expiration time corresponding to the first action signal and including the third expiration time in the set of expiration times;
selecting from the set an expiration time that will next occur to provide a new selected expiration time;
determining a new start time;
setting the time period approximately equal to a difference between the new selected expiration time and the new start time;
starting the timer at the new start time; and
once the timer sends the call back signal, sending action signals that correspond to the new selected expiration time.

18. The method of claim 15, wherein the first timing information includes a first indicator, and the method further comprises:
upon sending the first action signal, determining whether the first indicator is turned on or turned off; and
if the first indicator is turned off, setting the first flag to an inactive status.

19. An article of manufacture comprising a computer usable medium having computer readable program code instructions embodied therein to cause a computer to determine when to send a signal, the instructions having:
a computer readable program code module to receive a set of durations, the set of durations including at least two time durations, each duration corresponding to a respective action signal to be sent at the end of the respective duration;
a computer readable program code module to determine an expiration time corresponding to each duration;
a computer readable program code module to select the expiration time that is first to occur to provide a selected expiration time;
a computer readable program code module to send the action signal corresponding to the selected expiration time when the selected expiration time occurs.

20. The method of claim 19, wherein the instructions further have a computer readable program code module to determine a received time for each duration.

21. The method of claim 20, wherein the instructions further have a computer readable program code module to add each duration to its corresponding received time.

22. The method of claim 19, wherein the instructions further have a computer readable program code module to compare the expiration times to determine which of the expiration times is first to occur.

23. The method of claim 19, wherein the instructions further have a computer readable program code module to set a clock to send a signal at the expiration time.

24. An article of manufacture comprising a computer usable medium having computer readable program code instructions embodied therein to cause a computer to determine when to send a signal, the instructions having:
a computer readable program code module to determine a first expiration time;
a computer readable program code module to determine a second expiration time;
a computer readable program code module to compare the first expiration time to the second expiration time;
a computer readable program code module to select the first expiration time if the first expiration time is less than the second expiration time, and to select the second expiration time if the second expiration time is less than the first expiration time, and to select both the first and second expiration times if the first expiration time is approximately equal to the second expiration time;
a computer readable program code module to set a signal send time approximately equal to the selected one of the first expiration time and the second expiration time if the first expiration time is not approximately equal to the second expiration time, and to set a signal send time approximately equal to the first and second expiration time if the first expiration time is approximately equal to the second expiration time;
a computer readable program code module to determine a start time corresponding to the current time indicated by the clock;
a computer readable program code module to determine a time difference between the signal send time and the start time;
a computer readable program code module to set a time period of a timer approximately equal to the time difference so a call back signal is sent at the end of the time period;
a computer readable program code module to start the timer at the start time; and
a computer readable program code module to send, once the timer sends the call back signal, the first action signal if the first expiration time was selected, and to send the second action signal if the second expiration time was selected.

25. The article of manufacture of claim 24, wherein the instructions further have:
a computer readable program code module to select a next expiration time once the timer sends the call back signal, the next expiration time corresponding to the first expiration time if the first expiration time was not previously selected, and the next expiration time corresponding to the second expiration time if the second expiration time was not previously selected;
a computer readable program code module to determine a new start time;
a computer readable program code module to determine a new time difference between the next expiration time and the new start time;
a computer readable program code module to set a new time period approximately equal to the new time difference; and
a computer readable program code module to start the timer at the new start time.

26. The article of manufacture of claim 24, wherein the instructions further have:
a computer readable program code module to check a first indicator upon sending the first action signal, the first indicator corresponding to whether the first action signal should be sent again;
a computer readable program code module to determine a third expiration time if the first indicator indicates the first action signal should be sent again.

27. An article of manufacture comprising a computer usable medium having computer readable program code instructions embodied therein to cause a computer to determine when to send a signal, the instructions having:
a computer readable program code module to receive a set of durations, the set of durations including at least two time durations, each duration corresponding to a respective action signal to be sent at the end of the respective duration;
a computer readable program code module to determine an expiration time corresponding to each duration to provide a set of expiration times;
a computer readable program code module to compare the expiration times to determine which of the expiration times is first to occur;
a computer readable program code module to select the expiration time that is first to occur to provide a selected expiration time;
a computer readable program code module to determine a start time;
a computer readable program code module to determine a time difference between the selected expiration time and the start time;
a computer readable program code module to set a time period of a timer approximately equal to the time difference, the timer being capable of sending a call back signal at the end of the time period;
a computer readable program code module to start the timer at the start time; and
a computer readable program code module to send, once the timer sends the call back signal, the action signal corresponding to the selected expiration time.

28. The article of manufacture of claim 27, wherein the instructions further have:
a computer readable program code module to select from the set of expiration times the expiration time that is next to occur;
a computer readable program code module to determine a new start time;
a computer readable program code module to determine a new time difference between the selected expiration time that is next to occur and the start time;
a computer readable program code module to set the time period approximately equal to the new time difference;
a computer readable program code module to start the timer at the new start time; and
a computer readable program code module to send, once the timer sends the call back signal, the action signal corresponding to the selected expiration time that is next to occur.

29. The article of manufacture of claim 27, wherein the instructions further have a computer readable program code module to add to the set of expiration times an expiration time approximately equal to the time the action signal was sent plus the corresponding duration.

30. The article of manufacture of claim 27, wherein the instructions further have:
a computer readable program code module to check an indicator corresponding to the sent action signal to determine whether the indicator is turned on or turned off;
a computer readable program code module to add to the set of expiration times an expiration time approximately equal to the time the action signal was sent plus the corresponding duration, if the indicator is turned on.

31. An article of manufacture comprising a computer usable medium having computer readable program code instructions embodied therein to cause a computer to determine when to send a signal, the instructions having:
a computer readable program code module to receive first timing information corresponding to a first action signal, the first timing information including a first duration and a first flag;
a computer readable program code module to determine a first expiration time, if the first flag indicates an active status, and to include the first expiration time in a set of expiration times to be considered;
a computer readable program code module to receive second timing information corresponding to a second action signal, the second timing information including a second duration and a second flag;
a computer readable program code module to determine a second expiration time, if the second flag indicates an active status, and to include the second expiration time in the set of expiration times;
a computer readable program code module to select an expiration time in the set that will occur first, to provide a selected expiration time;
a computer readable program code module to determine a start time;
a computer readable program code module to set a time period of a timer approximately equal to a difference between the selected expiration time and the start time, the timer being capable of sending a call back signal at the end of the time period;
a computer readable program code module to start the timer at the start time; and
a computer readable program code module to send, once the timer sends the call back signal, action signals corresponding to the selected expiration time.

32. The article of manufacture of claim 31, wherein the instructions further have a computer readable program code module to set at least one of the flags corresponding to the selected expiration time to an inactive status once the corresponding action signal is sent.

33. The article of manufacture of claim 31, wherein the first timing information further includes a first indicator, and the instructions further have:
a computer readable program code module to determine whether the indicator is turned on or turned off;
a computer readable program code module to determine whether the first flag indicates an active status;
a computer readable program code module to determine a third expiration time corresponding to the first action signal, if the first flag indicates an active status and the indicator is turned on, and to include the third expiration time in the set of expiration times;
a computer readable program code module to select an expiration time in the set that will next occur to provide a new expiration time;
a computer readable program code module to determine a new start time;
a computer readable program code module to set a new time period approximately equal to a difference between the new expiration time and the new start time;
a computer readable program code module to start the timer at the new start time; and
a computer readable program code module to send, once the timer sends the call back signal, action signals corresponding to the new expiration time.

34. The article of manufacture of claim 31, wherein the first timing information further includes a first indicator, and the instructions further have:
a computer readable program code module to determine whether the first indicator is turned on or turned off; and
a computer readable program code module to set the first flag to an inactive status if the first indicator is turned off.
